(19) United States
(12) Patent Application Publication
(10) Pub. No.: US 2010/0055594 A1
(43) Pub. Date: Mar. 4, 2010

(54) Toner for developing electrostatically charged images

(75) Inventors: Yoshihito Suwa, Shizuoka-shi (JP); Shigeyoshi Takayanagi, Shizuoka-shi (JP); Naoki Kohata, Shizuoka-shi (JP)

Correspondence Address: JORDAN AND HAMBURG LLP, 122 EAST 42ND STREET, SUITE 4000, NEW YORK, NY, 10168, US

(73) Assignee: Tomoegawa Co., Ltd., Chuo-ku (JP)

(21) Appl. No.: 12/584,350

(22) Filed: Sep. 3, 2009

(30) Foreign Application Priority Data
Sep. 4, 2008 (JP) 2008-226561

(51) Int. Cl. G03G 9/08; G03G 9/087; G03G 9/09

(52) U.S. Cl. 430/108.5

(57) ABSTRACT

Toner for developing electrostatically charged images contains at least a binder resin, a colorant and a charge control agent. The charge control agent is an aromatic compound generating at least sulfur dioxide and a butylphenol upon thermal decomposition by raising temperature from room temperature to 250° C. at 10° C./min; and is one of or a mixture of two or more of a substance having both an aromatic ring to which one or more tert-butyl groups are attached and an aromatic ring to which one or more sulfonyl groups are attached, a mixture comprising a substance having an aromatic ring to which one or more tert-butyl groups are attached and a substance having an aromatic ring to which one or more sulfonyl groups are attached, and a substance of a chemical structure including an aromatic ring to which both one or more tert-butyl groups and one or more sulfonyl groups are attached.

### BACKGROUND OF THE INVENTION

The present invention relates to toners for developing electrostatically charged images (hereinafter referred to as “toners”) to be used for electrostatic recording, electrophotography and the like (hereinafter referred to as “electrophotography and the like”).

In recent years, images of electrophotography and the like are desired to be rendered colored for the need of enhancement in image quality and, in order to enhance color reproducibility of the images, good color developing properties are required for toners, especially for color toners.

In addition to being influenced by the tinges of colorants per se in a toner, the color developing properties of the toner are enhanced by finely dividing the colorants and homogenizing the dispersion of the colorants in the toner. For example, as a masterbatch process, a process is well known wherein a small amount of resin is melt-kneaded with a certain colorant under rigorous conditions to preliminarily produce a resin containing a high concentration of colorant with enhanced dispersion of the colorant (masterbatch) which is then used as a colorant for a toner.

The quality of color development of a toner is also influenced by tones of components, other than colorants, composing the toner, such as a binder resin, release agent, charge control agent and external additive. In particular, a charge control agent often possesses a conspicuous tone and, therefore, can be used with no problem for a black toner, but may not be used for a color toner because of the danger of causing tone failures.

Among known charge control agents, examples of positively chargeable charge control agents include nigrosine-based dyes, quaternary ammonium salt-based compounds, triphenylmethane-based compounds, imidazole-based compounds and polyamine resins. Also, examples of negatively chargeable charge control agents include azoic dyes containing metals such as Cr, Co, Al and Fe, metal salicylate compounds, metal alkylsalicylate compounds, calixarene compounds, boron complexes and high molecular weight charge control agents. In particular, while substances based on metal complexes can provide relatively high charging, many of them possess conspicuous tones inherent to each of them.

Patent Reference 1: Japanese Unexamined Patent Publication No. 2007-101593

### SUMMARY OF THE INVENTION

The present invention has been made in the light of the problem as described above and has an object to provide toners having good color developing properties without being influenced by tones of charge control agents.

The present invention has successfully solved the problem described above by means of technical constitution to be described below.

(1) A toner for developing electrostatically charged images containing at least a binder resin, a colorant and a charge control agent, wherein the charge control agent comprises an aromatic compound which satisfies the conditions (A) and (B):

(A) the compound generates at least sulfur dioxide and a butylphenol as thermally decomposed products when the temperature is raised from room temperature to 250° C. at a rate of 10° C./min; and

(B) the compound is any one of or a mixture of two or more of (a) to (c) below:

(a) a substance of a chemical structure having both an aromatic ring to which one or more tert-butyl groups are attached and an aromatic ring to which one or more sulfonyl groups are attached,

(b) a mixture comprising a substance of a chemical structure having an aromatic ring to which one or more tert-butyl groups are attached and a substance of a chemical structure having an aromatic ring to which one or more sulfonyl groups are attached, and

(c) a substance of a chemical structure including an aromatic ring to which both one or more tert-butyl groups and one or more sulfonyl groups are attached.

(2) The toner for developing electrostatically charged images according to (1) described above, wherein the aromatic compound includes a tetra-substituted aromatic ring.

(3) The toner for developing electrostatically charged images according to (1) or (2) described above, wherein the aromatic compound has an aromatic ring structure with two hydrogens at the ortho or meta positions in relation to the tert-butyl groups.

(4) The toner for developing electrostatically charged images according to any one of (1) to (3) described above, wherein the aromatic compound is the trade name “T-8” from Hodogaya Chemical Co. Ltd.

(5) The toner for developing electrostatically charged images according to (1) described above, wherein the binder resin comprises a copolymer of a styrene and an acrylate ester, a copolymer of a cyclic olefin and an unsaturated aliphatic or a polyester.

According to the present invention, toners having good color developing properties without being influenced by tinges of charge control agents may be provided.

### DETAILED DESCRIPTION OF THE INVENTION

The toners according to the present invention are for developing electrostatically charged images, containing at least a binder resin, a colorant and an aromatic compound as a charge control agent. The toners according to the present invention may be produced by any method, such as melt-kneading, suspension polymerization or emulsion polymerization. Also, the toners according to the present invention can use, as a component of the binder resin, a known resin, such as a copolymer of a styrene and an acrylate ester, a copolymer of a cyclic olefin and an unsaturated aliphatic or a polyester.

### Aromatic Compound

An aromatic compound to be added to the toners according to the present invention is a colorless substance which satisfies the conditions (A) and (B) described above.

It has been found that when such an aromatic compound is added to a toner, the toner may more easily be charged (charging may be built up quicker) and the amount of charging may be maintained high in a stable manner. In other words, the aromatic compound described above may be used as a charge control agents for the toner. Although the reasons for this are not clear, it may be assumed that a substance having an aromatic ring is versatile in electron configuration in relation to external potential variation due to the π orbital carried by the aromatic ring and therefore has a propensity for stabilizing the potential of the substance, that a sulfonyl group as an electron-withdrawing functional group is attached to the aromatic ring to promote polarization in which the sulfonyl group is on the negative side and that a tert-butyl group as an electron-donating functional group is attached to the aromatic ring to enhance the electron-donating property of the aromatic ring, therefore further increasing the polarization of the sulfonyl group. Due to a synergistic effect from these, it may be assumed that the aromatic compound has a stable potential in relation to external potential variation and is more easily negatively charged as a whole, so that good performance as a charge control agent may be exhibited. Toners having such an aromatic compound added are negatively charged.

The aromatic compound described above generates at least sulfur dioxide and a butylphenol as thermally decomposed products when the temperature is raised from room temperature to 250° C. at a rate of 10° C./min. A room temperature herein refers to 23° C. at a relative humidity of 65%.

In addition to the characteristics described above, in order to stabilize its own chemical structure or to enhance the charge control characteristics to a toner when added to the toner, the aromatic compound described above preferably includes a tetra-substituted aromatic ring or preferably has two hydrogens at the ortho or meta positions in relation to the tert-butyl group described above. More preferably, the aromatic compound simultaneously includes a tetra-substituted aromatic ring and have two hydrogens at the ortho or meta positions in relation to the tert-butyl group described above.

Suitable as an aromatic compound satisfying the conditions (A) and (B) described above is the trade name “T-8” from Hodogaya Chemical Co. Ltd.

The amount of the aromatic compound as a charge control agent for toners is preferably from 0.05 to 10 parts by weight in relation to 100 parts of the binder resin. The aromatic compound described above may function as a charge control agent for toners by being incorporated in toner particles or attached to the surface of toner particles.

Next, toner materials other than the charge control agent will be described.

### Binder Resin

Examples of binder resins to be used according to the present invention include homopolymers and copolymers of styrenes such as styrene and chlorostyrene, monoolefins such as ethylene, propylene, butylene and isobutylene, vinyl esters such as vinyl acetate, vinyl propionate, vinyl benzoate and vinyl butyrate, esters of α-methylene aliphatic monocarboxylic acids such as methyl acrylate, ethyl acrylate, butyl acrylate, octyl acrylate, dodecyl acrylate, phenyl acrylate, methyl methacrylate, ethyl methacrylate, butyl methacrylate and dodecyl methacrylate, vinyl ethers such as vinyl methyl ether, vinyl ethyl ether and vinyl butyl ether, vinyl ketones such as vinyl methyl ketone, vinyl hexyl ketone and vinyl isopropenyl ketone, cyclic olefins having double bonds such as cyclobutene, cyclopentene, cyclohexene, cyclopentadiene, cyclohexadiene, norbornene and dicyclopentadiene.

Also, polyester resins produced from carboxylic acids such as maleic acid, fumaric acid and phthalic acid and alcohols such as bisphenol A (including EO/PO adducts) and ethylene glycol may be mentioned.

Among them, styrene-(meth)acrylate ester copolymer resins, cyclic olefin copolymer resins such as ethylene-norbornene and polyester resins are preferably used.

In view of durability in particular, polyester resins are preferably used.

The amount of the binder resin according to the present invention is preferably from 80 to 95 parts by weight in case of a non-magnetic toner in relation to 100 parts by weight of the toner.

### Colorant

Next, colorants will be discussed.

As pigment-based yellow colorants, such compounds as represented by condensed azo compounds, isoindolinone compounds, anthraquinone compounds, azo metal complex methine compounds and allylamide compounds are used.

Specifically, C. I. Pigment Yellow 3, 7, 10, 12, 13, 14, 15, 17, 23, 24, 60, 62, 73, 74, 75, 83, 93, 94, 95, 99, 100, 101, 104, 108, 109, 110, 111, 117, 122, 123, 128, 129, 138, 139, 147, 148, 150, 155, 166, 168, 169, 177, 179, 180, 181, 183, 185, 191:1, 191, 192, 193 and 199 are preferably used.

As dye-based yellow colorants, C. I. Solvent Yellow 33, 56, 79, 82, 93, 112, 162 and 163 and C. I. Disperse Yellow 42, 64, 201 and 211 may be mentioned for example.

As magenta colorants, condensed azo compounds, diketopyrolopyrrole compounds, anthraquinones, quinacridone compounds, basic dye lake compounds, naphthol compounds, benzimidazolone compounds, thioindigo compounds and perylene compounds are used.

Specifically, C. I. Pigment Red 2, 3, 5, 6, 7, 23, 48:2, 48:3, 48:4, 57:1, 81:1, 122, 146, 166, 169, 177, 184, 185, 202, 206, 220, 221, 238, 254 and 269 and C. I. Pigment Violet 19 are especially preferred.

As cyan colorants, copper phthalocyanine compounds and derivatives thereof, anthraquinone compounds, basic dye lake compounds and the like may be used.

Specifically, C. I. Pigment Blue 1, 7, 15, 15:1, 15:2, 15:3, 15:4, 60, 62 and 66 are particularly preferably used.

As black colorants, carbon blacks such as Acetylene Black, Lamp Black and Aniline Black, graphite, nigrosine, magnetic particles and the like such as iron black, triiron tetraoxide, iron manganese oxide, iron zinc oxide and iron nickel oxide may be used. In addition, those toned in black using the yellow, magenta and cyan colorants described above are used.

The added amount of a colorant is from 2 to 20 parts by weight and preferably from 2 to 15 parts by weight in relation to 100 parts by weight of the binder resin. Further, in consideration of preferred transmission of toner images through OHP films, the colorant is used preferably in the range of less than 12 parts by weight and most preferably in the range of 3 to 9 parts by weight. Although the colorant may be added singly to a feedstock, it is more preferred to enhance the dispersion of the colorant in the toner by a known method such as masterbatch process to more finely and homogeneously disperse the colorant in the toner so that images with better tones may be obtained. The masterbatch process involves melt-kneading a certain colorant with a resin to be a binder resin under rigorous conditions to preliminarily produce a resin containing a high concentration of colorant with enhanced dispersion of the colorant (masterbatch) which is then used as a colorant for a toner. When the masterbatch is added as a toner material, it is necessary to determine the added amounts of the masterbatch and each of other components such as binder resin, considering that the content of the colorant in the masterbatch corresponds to the amount of the colorant added to the toner and that the resin in the masterbatch makes up part of the binder resin component.

### Release Agent

A release agent (wax) may be added to the toner according to the present invention, if necessary. Appropriate addition of a release agent can improve offset resistance of the toner, glossiness of images and the like.

Examples of release agents may include animal-derived waxes such as beeswax, spermaceti wax, wool wax and shellac wax, plant-derived waxes such as carnauba wax, haze wax, rice wax and candelilla wax, petroleum-derived waxes such as paraffin wax and microcrystalline wax, mineral-derived waxes such as montan wax and ozokerite, synthetic waxes such as polyolefin wax, Fischer Tropsch wax, fat and oil-based synthetic waxes (higher fatty acid esters, fatty acid amides, ketones and amines) and hydrogen-hardened waxes solid at ordinary temperature as well as various processed or modified waxes such as modified waxes having aromatic groups, hydrocarbon compounds having alicyclic groups, long-chain carboxylic acids having long-chain hydrocarbon chains with 12 or more carbons, fatty acid metal salts, fatty acid amides, fatty acid bisamides, oxidized waxes, waxes incorporated with synthetic resins (ethylene-vinyl acetate copolymer, polyethylene, synthetic rosin and the like) and modified montan wax. The release agent may be composed of any one of or a mixture of the components described above. When multiple release agents are used for producing a toner by melt-kneading, it is preferred to preliminarily mix the release agents before melt-kneading with a binder resin so that the dispersion of the release agents in the toner may be homogenized and offset resistance of the toner and glossiness of images may homogenously be obtained. Although a hot-melt kneading machine of batch type (for example, pressurizing kneader or Banbury mixer) or continuous type is used for mixing multiple release agents, a single-screw or double-screw, continuous extruder is preferred for the advantage of continuous production or the like. For example, a double-screw extruder of the type KTK from Kobe Steel, Ltd., a double-screw extruder of the type TEM from Toshiba Machine Co., Ltd., a double-screw extruder from KCK Co., a double-screw extruder of the type PCM from Ikegai Iron Works Co., a double-screw extruder from Kuriyama Seisakusho Co., a Ko-kneader from Buss AG and the like are preferred. Also, open-roll type continuous kneaders are usable.

The total added amount of the release agents is less than 30 parts by weight and preferably from 2 to 20 parts by weight in relation to 100 parts by weight of the resin binder. When the amount is 30 parts by weight or more, the release agents may separate in the toner, degrading such properties as charging characteristics, thermal characteristics and photoreceptor cleaning properties of the toner. When the amount is less than 2 parts by weight, sufficient offset resistance may not be obtained at the time of image fixing by thermal rollers, possibly creating offset images or causing fed sheets to stick to and curl around fixing rollers.

In a process for producing a toner by melt-kneading, a feedstock comprising a binder resin, a colorant and a charge control agent is melt-kneaded to obtain a kneaded product. It is preferred to add a release agent as a feedstock component. In case of a magnetic toner, a magnetic powder is also added to the feedstock.

Although a hot-melt kneading machine of batch type (for example, pressurizing kneader or Banbury mixer) or continuous type is used for the kneading step, a single-screw or double-screw, continuous extruder is preferred for the advantage of continuous production or the like. For example, a double-screw extruder of the type KTK from Kobe Steel, Ltd., a double-screw extruder of the type TEM from Toshiba Machine Co., Ltd., a double-screw extruder from KCK Co., a double-screw extruder of the type PCM from Ikegai Iron Works Co., a double-screw extruder from Kuriyama Seisakusho Co., a Ko-kneader from Buss AG and the like are preferred. Also, open-roll type continuous kneaders are usable. Thereafter, the kneaded product is cooled and solidified by a cooling step.

Then the kneaded product as cooled and solidified is ground and classified to obtain a classified toner.

First, the kneaded product is coarsely ground by a crusher, hammer mill, feather mill or the like and finely ground by a jet mill, counter jet mill, high-speed rotary mill or the like to gradually grind to a predetermined toner particle size.

Then the toner is classified by an elbow jet of inertial classification system, a microplex of centrifugal classification system, a DS separator, a dry air classifier or the like to obtain a classified toner having a volume average particle diameter of 3 to 18 μm.

The coarse powder obtained during the classification step may be returned to the grinding and classifying steps and the fine powder may be returned to the kneading step for reuse.

Next, external additives are attached to the classified toner, if necessary.

The classified toner is formulated with various external additives at predetermined amounts and the formulation is agitated and mixed using a high-speed agitator and so on that applies shear force to the powder, such as a Henschel mixer or super mixer.

In so doing, heat is generated inside of the external additive machine so that agglomerates may easily be formed. It is therefore preferred to adjust the temperature by cooling the surroundings of the vessel of the external additive machine with water. Further, the temperature of the materials in the vessel of the external additive machine is preferably at or below the control temperature that is lower by approximately 10° C. than the glass transition temperature of the resin.

The toners according to the present invention are obtained by the process described above and have a volume average particle diameter preferably of 3 μm to 15 μm and more preferably of 5 μm to 10 μm. When the volume average particle diameter is less than 3 μm, ultrafine powder of less than 2 μm will increase, causing fogging, a decrease in image density, black spots on photoreceptors or filming, fusing at developing sleeves or layer thickness regulating blades or the like. On the other hand, when the particle diameter is greater than 15 μm, resolution will decrease, preventing quality images from being obtained.

The volume average particle diameter according to the present invention is given by measuring the volume distribution using a Coulter counter TA-II (Coulter, Inc.) through a 100 μm aperture tube.

The degree of circularity of the toners according to the present invention is from 0.80 to 0.98 and preferably from 0.90 to 0.96. When the degree of circularity is below 0.80, flowability will be insufficient to decrease the amount of charging to cause a decrease in image density, while, over 0.98, failure in cleaning of photoreceptors and spattering of toners within printers will tend to occur, possibly increasing the consumption of the toners or degrading image quality.

The degree of circularity is represented as:

Degree of Circularity=π(diameter of a circle equal in surface area to particle image)/(perimeter of particle image)

and given by a flow particle image analyzer (trade name FPIA-2000, Sysmex Corporation).

The toners obtained may be used for one-component development, two-component development and other development systems. Regarding two-component development systems, the toners are admixed with carriers for use.

As carriers for two-component development systems, nickel, cobalt, iron oxide, ferrite, iron, glass beads and the like may be used, for example. These carriers may be used alone or in combination of two or more. The carriers may preferably have an average particle diameter of 20 to 150 μm. Also, the surface of the carriers may be coated with a coating agent such as fluorine-based resin, acrylic resin or silicone-based resin.

The toners according to the present invention may be monochrome toners or color toners, but may preferably be used as color toners, in particular full-color toners, in which improvement in tone of images may conspicuously be exhibited.

### External Additive

The toners according to the present invention preferably have an external additive attached on the surface in view of imparting flowability.

Various inorganic or organic external additives may be used. For the purpose of improving flowability of the toners and inhibiting coagulation, inorganic fine powders of silica, titanium oxide, alumina, zinc oxide, magnesium oxide, strontium titanate, metal soaps (such as lithium stearate and zinc stearate) and the like are preferred.

The amount of an external additive to be mixed varies depending on the external additive used and the average particle diameter, the particle size distribution of toner particles and the like and may appropriately be such that the toners may have desired flowability. Generally 0.05 to 10 parts by weight and further 0.1 to 8 parts by weight in relation to 100 parts by weight of the toner particles are preferred.

If the amount of the additive added is less than 0.05 parts by weight, the effect of improving flowability will be insufficient and the storage stability at high temperatures will degrade, while the amount is more than 10 parts by weight, the external additive may partly separate to undesirably cause filming on photoreceptors or accumulate inside of a developer tank to cause deterioration of the charging function of the developer and the like.

Also, in consideration of the stability of the external additive in high humidity conditions, it is more preferred that inorganic fine powders are hydrophobicated by a treatment agent such as silane coupling agent. Further, when charging properties are taken into consideration, negatively charging agents such as dimethyldichlorosilane, monooctyltrichlorosilane, hexamethyldisilazane and silicone oil or positively charging agents such as aminosilane may be used.

In addition, other additives not for the purpose of improving flowability, such as fine powders of magnetite, ferrite, conductive titanium, antimony oxide, tin oxide, cerium oxide, hydrotalcite compounds, acrylic beads, silicone beads and polyethylene beads may appropriately be mixed for the purpose of controlling the electrical resistance of the toner or as abrasives and so on. The amount of such additives is preferably from 0.005 to 10 parts by weight in relation to 100 parts by weight of the toner.

Further, impalpable resin powders such as polyethylene tetrafluoride resin powder and polyvinylidene fluoride resin powder may also be attached as external additives. The proportion of such resin powders to be added to the toner may range from 0.01 to 8 parts by weight, preferably from 0.1 to 5 parts by weight and more preferably from 0.1 to 4 parts by weight in relation to 100 parts by weight of the toner, as appropriate.

Attachment of the external additives to the toner particles may preferably be carried out by mixing due to dry blending. Examples of mixing apparatuses may include double cone mixers, V-type mixers, drum-type mixers, super mixers, Henschel mixers and Nauta mixers.

### EXAMPLES

The present invention will be described in more detail with reference to examples below, to which the present invention is not limited in any way.

### Example 1

First, a mixture of the following formulation was kneaded for 30 minutes by a roll-type kneader to produce a pigment masterbatch.

Polyester resin (Mitsubishi Rayon Co., Ltd., Mw 25,000, Mn 5,000, Tg (shoulder) 60° C.) 70 parts by weight

Colorant: cyan pigment (trade name “Pigment 15:4”, Dainichiseika Color & Chemicals Mfg. Co., Ltd.) 30 parts by weight

Then the following formulation was homogenously mixed using a Henschel mixer (trade name “Henschel Mixer 20L”, Mitsui Mining Co., Ltd.) at 2,800 rpm for five minutes and then melt-kneaded using a double-screw kneader/extruder (trade name “PCM-30”, Ikegai Iron Works Co.) at 200 rpm with a discharge rate of 3.0 kg/hr. The kneaded product was calendered using a twin-roll mill and left to cool.

Pigment masterbatch above 11.0 parts by weight

Binder resin: polyester resin (same as one used for producing the masterbatch) 89.5 parts by weight

Charge control agent: aromatic compound (trade name “T-8”, Hodogaya Chemical Co. Ltd.) 2.0 parts by weight

Release agent: ester wax (trade name “WEP-8”, NOF Corporation) 7.0 parts by weight

Then the kneaded product as cooled was coarsely ground by a hammer mill and finely ground by a jet mill (trade name “100 AFG”, Hosokawa Micron Corporation).

Classification was then performed using a dry air classifier (trade name “100 ATP”, Hosokawa Micron Corporation) to obtain a classified toner having a volume average particle diameter of 7.1 μm and a degree of circularity of 0.892.

Next, an external additive comprising silica and titanium oxide to be described below was added to 100 parts by weight of the classified toner and mixing was performed for five minutes using a 10 L Henschel mixer at 2,800 rpm to obtain a toner.

Silica (Clariant Japan, average primary particle diameter 17.5 nm, BET specific surface area 140 m²/g) 0.2 parts by weight

Titanium oxide (Aerosil Co., Ltd., average primary particle diameter 10 nm, BET specific surface area 65±10, treated with octylsilane) 0.5 parts by weight

Further, in a manner similar to the above except for replacing the cyan pigment with a magenta pigment (trade name “Pigment 57-1”, Dainichiseika Color & Chemicals Mfg. Co., Ltd.), a yellow pigment (trade name “Fast Yellow 74-16”, Sanyo Color Works, Ltd.) and a black pigment (trade name “Carbon Black #40”, Mitsubishi Chemical Corporation), magenta, yellow and black toners were obtained.

As described above, a non-magnetic, one-component developer of Example 1 was produced.

### Example 2

The polyester resin and the release agent in Example 1 were replaced with an alicyclic olefin-based resin and a carnauba wax below.

Alicyclic olefin-based resin: ethylene-norbornene copolymer (trade name “TOPAS COC”, Ticona, weight average molecular weight (Mw) 200,000, number average molecular weight (Mn) 5,000, Mw/Mn 40)

Release agent: carnauba wax (trade name “Carnauba Wax Powder No. 2”, S. Kato & Co.)

In a manner similar to that of Example 1 except the above, a non-magnetic, one-component developer of Example 2 was obtained.

### Example 3

The polyester resin and the release agent in Example 1 were replaced with a styrene-acrylate ester copolymer and a polyethylene wax below.

Styrene-acrylate ester copolymer resin (trade name “CPR 100”, Mitsui Chemicals, Inc.)

Release agent: polyethylene wax (trade name PE-130, melting point 130° C., Hoechst AG)

In a manner similar to that of Example 1 except the above, a non-magnetic, one-component developer of Example 3 was obtained.

### Example 4

Five parts by weight of each of the cyan, magenta, yellow and black toners obtained in Example 1 were mixed with 95.0 parts by weight of a ferrite carrier 30 μm in average particle diameter (Powdertech Co., Ltd.) to obtain cyan, magenta, yellow and black developers respectively.

As described above, a non-magnetic, two-component developer of Example 4 was produced.

### Example 5

In a manner similar to that of Example 4 except for replacing the toner with the toner of Example 2, a non-magnetic, two-component developer of Example 5 was produced.

### Example 6

In a manner similar to that of Example 4 except for replacing the toner with the toner of Example 3, a non-magnetic, two-component developer of Example 6 was produced.

### Comparative Examples 1 to 6

The charge control agent used in Examples 1 to 6 was replaced with a charge control agent comprising a salicylate-based chromium complex below.

Charge control agent: salicylate-based chromium complex (trade name “BONTRON E-81”, Orient Chemical Industries, Ltd.)

In a manner similar to those of Examples 1 to 6 except the above, non-magnetic, one-component developers of Comparative Examples 1 to 3 and non-magnetic, two-component developers of Comparative Examples 4 to 6 were obtained.

Principal conditions for producing the toners of Examples and Comparative Examples are shown in Table 1.

TABLE 1

| | | | release | charge control |
|---|---|---|---|---|
| | developer types | binder resins | agents | agents |
| Ex. 1 | non-magnetic, | polyester resin | ester | T-8 |
| | one-component | | | |
| Ex. 2 | non-magnetic, | alicyclic olefin | carnauba | T-8 |
| | one-component | resin | | |
| Ex. 3 | non-magnetic, | styrene-acrylate- | polyethylene | T-8 |
| | one-component | based resin | | |
| Ex. 4 | non-magnetic, | polyester resin | ester | T-8 |
| | two-component | | | |
| Ex. 5 | non-magnetic, | alicyclic olefin | carnauba | T-8 |
| | two-component | resin | | |
| Ex. 6 | non-magnetic, | styrene-acrylate- | polyethylene | T-8 |
| | two-component | based resin | | |
| Com. | non-magnetic, | polyester resin | ester | E-81 |
| Ex. 1 | one-component | | | |
| Com. | non-magnetic, | alicyclic olefin | carnauba | E-81 |
| Ex. 2 | one-component | resin | | |
| Com. | non-magnetic, | styrene-acrylate- | polyethylene | E-81 |
| Ex. 3 | one-component | based resin | | |
| Com. | non-magnetic, | polyester resin | ester | E-81 |
| Ex. 4 | two-component | | | |
| Com. | non-magnetic, | alicyclic olefin | carnauba | E-81 |
| Ex. 5 | two-component | resin | | |
| Com. | non-magnetic, | styrene-acrylate- | polyethylene | E-81 |
| Ex. 6 | two-component | based resin | | |

Comparisons and evaluations were made as below on the toners and the developers of Examples and Comparative Examples.

### Evaluation of One-Component Developers

The one-component developers of Examples 1 to 3 and Comparative Examples 1 to 3 were printed on size A4 copier papers (wood-free papers) at a print rate of 6% using a commercially available, compact laser printer of non-magnetic, one-component system (print-out rate, A4, horizontal, 16 sheets/min).

Testing was conducted at a temperature of 25° C. and a relative humidity of 65%.

### Evaluation of Two-Component Developers

The two-component developers of Examples 4 to 6 and Comparative Examples 4 to 6 were placed in a developing device of a copier for negatively polarizable toners of non-magnetic, two-component developing system and printed on size A4 copier papers (wood-free papers) at a print rate of 6%.

Testing was conducted at a temperature of 25° C. and a relative humidity of 65%.

Electrostatic Property of Toner Particles

Amounts of electrostatic charge after printing 2,000 sheets and after printing 100,000 sheets were measured to evaluate the difference as electrostatic property.

(amount of electrostatic charge after printing 2,000 sheets)−(amount of electrostatic charge after printing 100,000 sheets)

o: less than 5.0 μC/g
x: at or more than 5.0 μC/g

The amounts of electrostatic charge were measured by a qm meter from Epping GmbH.

Next, the one-component developers and the two-component developers of Examples and Comparative Examples were subjected to a continuous printing test up to 50,000 sheets, using a printer or copier of each of the development systems described above, at a print rate of 20%, on size A4 copier papers (wood-free papers) at print-out rates of 16 sheets/min for the one-component developers and 24 sheets/min for the two-component developers under the conditions of a low development potential and low transfer potential (development voltage −250 V, primary transfer voltage 800 V).

Tones of the images were then evaluated.

### Tones

Tones were evaluated by visually examining the tones and the development properties of the color print other than black on the printed copier papers. In particular, the evaluations were made focusing on the development of the yellow color.

o: good
x: dull

### Image Density

Image densities after printing 100,000 sheets as described above were measured and evaluated.

The image densities were measured using a reflective densitometer (trade name: RD-914, Macbeth).

o: 1.3 or higher, practically satisfactory
x: less than 1.3, practically unsatisfactory

### Fouling

For fouling of non-image portions of the copier papers under the development conditions described above, the number of toner stains on the non-image portions of the transfer papers were counted and evaluated in terms of number of stains per cm² (stains/cm²) into four levels according to the standard below.

o: 0 to 100 (stains/cm²)
x: 101 or more

The results of comparisons and evaluations of the toners and the developers in Examples and Comparative Examples are shown in Table 2.

TABLE 2

| | electrostatic | | image | |
|---|---|---|---|---|
| | property | tone | density | fouling |
| Ex. | | | | |
| 1 | ◯ | ◯ | ◯ | ◯ |
| 2 | ◯ | ◯ | ◯ | ◯ |
| 3 | ◯ | ◯ | ◯ | ◯ |
| 4 | ◯ | ◯ | ◯ | ◯ |
| 5 | ◯ | ◯ | ◯ | ◯ |
| 6 | ◯ | ◯ | ◯ | ◯ |
| Com. | | | | |
| Ex. | | | | |
| 1 | ◯ | X | ◯ | ◯ |
| 2 | ◯ | X | ◯ | ◯ |
| 3 | ◯ | X | ◯ | ◯ |
| 4 | ◯ | X | ◯ | ◯ |
| 5 | ◯ | X | ◯ | ◯ |
| 6 | ◯ | X | ◯ | ◯ |

As shown in Table 2, Examples 1 to 6 and Comparative Examples 1 to 6 were practically satisfactory except the tone.

Only the tone was unsatisfactory with Comparative Examples 1 to 6 which did not use the charge control agent (trade name “T-8”). The reason for this is that the coloring of the salicylate-based chromium complex as a charge control agent was blended with the color of the colorant to dull the tone of the color toner. This tendency of tone dulling was most conspicuous with the pale yellow toner. On the contrary, the tones of the toners of Examples 1 to 6 were good, because the aromatic compound as a charge control agent used according to the present invention provided outstanding effects. The aromatic compound is colorless and, however, possesses high and stable electrification performance comparable to that of conventional metal complex-based charge control agents.

As seen from the results above, according to the present invention, by using the aromatic compound described above as a charge control agent, toners having good color developing properties without being influenced by tones of charge control agents may be provided, without impairing toner performance such as electrification property.

1. A toner for developing electrostatically charged images containing at least a binder resin, a colorant and a charge control agent, wherein the charge control agent comprises an aromatic compound which satisfies the conditions (A) and (B):
(A) the compound generates at least sulfur dioxide and a butylphenol as thermally decomposed products when the temperature is raised from room temperature to 250° C. at a rate of 10° C./min; and
(B) the compound is any one of or a mixture of two or more of (a) to (c) below:
(a) a substance of a chemical structure having both an aromatic ring to which one or more tert-butyl groups are attached and an aromatic ring to which one or more sulfonyl groups are attached,
(b) a mixture comprising a substance of a chemical structure having an aromatic ring to which one or more tert-butyl groups are attached and a substance of a chemical structure having an aromatic ring to which one or more sulfonyl groups are attached, and
(c) a substance of a chemical structure including an aromatic ring to which both one or more tert-butyl groups and one or more sulfonyl groups are attached.

2. The toner for developing electrostatically charged images according to claim 1, wherein the aromatic compound includes a tetra-substituted aromatic ring.

3. The toner for developing electrostatically charged images according to claim 1, wherein the aromatic compound has an aromatic ring structure with two hydrogens at the ortho or meta positions in relation to the tert-butyl groups.

4. The toner for developing electrostatically charged images according to claim 1, wherein the aromatic compound is the trade name “T-8” from Hodogaya Chemical Co. Ltd.

5. The toner for developing electrostatically charged images according to claim 1, wherein the binder resin comprises a copolymer of a styrene and an acrylate ester, a copolymer of a cyclic olefin and an unsaturated aliphatic or a polyester.
